(19) United States
(12) Patent Application Publication
(10) Pub. No.: US 2020/0215828 A1
(43) Pub. Date: Jul. 9, 2020

(54) IMAGE FORMING METHOD

(71) Applicant: Konica Minolta, Inc., Tokyo (JP)

(72) Inventors: Shogo Watanabe, Tokyo (JP); Go Yamaguchi, Tokyo (JP); Masashi Ikeda, Tokyo (JP)

(21) Appl. No.: 16/692,399

(22) Filed: Nov. 22, 2019

(30) Foreign Application Priority Data
Jan. 9, 2019 (JP) 2019-001849

(51) Int. Cl. B41J 11/00

(52) U.S. Cl. CPC B41J 11/002

(57) ABSTRACT

An image forming method includes: discharging an inkjet actinic ray curable white ink containing an actinic ray polymerizable compound, a gelling agent, and titanium oxide from a nozzle of an inkjet head to attach the inkjet actinic ray curable white ink to a surface of a recording medium; irradiating the inkjet actinic ray curable white ink attached to the surface of the recording medium with an actinic ray to cure the inkjet actinic ray curable white ink; discharging an inkjet actinic ray curable ink containing an actinic ray polymerizable compound from a nozzle to attach the inkjet actinic ray curable ink to a surface of a white cured film obtained by curing the inkjet actinic ray curable white ink; and irradiating the inkjet actinic ray curable ink attached to the surface of the white cured film with an actinic ray to cure the inkjet actinic ray curable ink.

The entire disclosure of Japanese patent Application No. 2019-001849, filed on Jan. 9, 2019, is incorporated herein by reference in its entirety.

### BACKGROUND

### Technological Field

The present invention relates to an image forming method.

### Description of the Related Art

An inkjet image forming method is used in various printing fields because of being able to form an image easily and inexpensively. As one type of an inkjet ink, an ink containing an actinic ray polymerizable compound to be cured by irradiation with an actinic ray and a polymerization initiator (hereinafter, also simply referred to as “actinic ray curable ink”) is known. When droplets of an actinic ray curable ink are attached to a surface of a recording medium and the attached droplets are irradiated with an actinic ray, a cured film obtained by curing the ink is formed on the surface of the recording medium. By forming this cured film, a desired image can be formed. An image forming method using an actinic ray curable ink has attracted attention because an image having high adhesion can be formed regardless of water absorbency of a recording medium.

There is known an image forming method for producing a desired aesthetic appearance by using an actinic ray curable white ink and an actinic ray curable color ink in combination. For example, when an image is formed with an inkjet ink on a transparent film or vapor-deposited paper, there is known an image forming method for attaching an actinic ray curable white ink having concealability to a transparent film or vapor-deposited paper and curing the ink to form a white cured film, and forming a cured film on the white cured film using an actinic ray curable color ink to enhance visibility.

For example, JP 2011-218794 A discloses a recording method for curing a first ink containing a white-based coloring material, discharging a second ink onto the cured first ink, and curing the second ink. Here, it is generally known that titanium oxide having high concealability is used as a pigment for an actinic ray curable white ink.

The present inventors have found that when a cured film of an actinic ray curable ink (hereinafter also referred to as a second ink) is formed on a surface of a cured film formed of an actinic ray curable white ink containing titanium oxide as a pigment and a gelling agent, adhesion between the cured films may be low.

### SUMMARY

The present invention has been achieved in view of the above circumstances, and an object of the present invention is to provide an image forming method capable of increasing adhesive force between cured films when a cured film is formed with an actinic ray curable ink on a surface of a cured film formed with an actinic ray curable white ink containing titanium oxide and a gelling agent.

To achieve the abovementioned object, according to an aspect of the present invention, an image forming method reflecting one aspect of the present invention comprises: discharging an inkjet actinic ray curable white ink containing an actinic ray polymerizable compound, a gelling agent, and titanium oxide from a nozzle of an inkjet head to attach the inkjet actinic ray curable white ink to a surface of a recording medium; irradiating the inkjet actinic ray curable white ink attached to the surface of the recording medium with an actinic ray to cure the inkjet actinic ray curable white ink; discharging an inkjet actinic ray curable ink containing an actinic ray polymerizable compound from a nozzle of an inkjet head to attach the inkjet actinic ray curable ink to a surface of a white cured film obtained by curing the inkjet actinic ray curable white ink; and irradiating the inkjet actinic ray curable ink attached to the surface of the white cured film with an actinic ray to cure the inkjet actinic ray curable ink, wherein the surface of the white cured film on which the inkjet actinic ray curable ink lands has an arithmetic average height Sa of 0.05 μm or more and 0.30 μm or less.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic view illustrating an exemplary configuration of an image forming apparatus according to an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

An image forming method according to an embodiment of the present invention includes: (1) a first image forming step in which an inkjet actinic ray curable white ink (white ink) containing an actinic ray polymerizable compound, a gelling agent, and titanium oxide is discharged from a nozzle of an inkjet head to attach the inkjet actinic ray curable white ink to a surface of a recording medium; (2) a first exposure step in which the inkjet actinic ray curable white ink attached to the surface of the recording medium is irradiated with an actinic ray to cure the inkjet actinic ray curable white ink; (3) a second image forming step in which an inkjet actinic ray curable ink (second ink) containing an actinic ray polymerizable compound is discharged from a nozzle of an inkjet head to attach the inkjet actinic ray curable white ink to a surface of a white cured film obtained by curing the inkjet actinic ray curable white ink; and (4) a second exposure step in which the inkjet actinic ray curable ink attached to the surface of the white cured film is irradiated with an actinic ray to cure the inkjet actinic ray curable ink, in which the surface of the white cured film has an arithmetic average height Sa of 0.05 μm or more and 0.30 μm or less.

According to the finding of the present inventors, a reason why the above problems can be solved by the present invention is considered as follows.

It is considered that an anchor effect due to the roughness of the surface of the white cured film contributes largely to adhesion between the white cured film and the second ink cured film. Therefore, in general, as the roughness of the surface of the white cured film is larger, the degree of improvement in adhesion due to the anchor effect is larger, and therefore it is considered that the adhesion between the white cured film and the second ink cured film is better.

Here, it is known that a surface of a cured film obtained by curing an ink containing a gelling agent becomes uneven by deposition of the gelling agent crystallized after the ink is attached to a recording medium. Therefore, the surface of the cured film obtained by curing the ink containing a gelling agent is expected to have higher adhesion with a cured film formed with another ink.

However, it is known that wettability is reduced due to a lotus effect on a rougher surface having high hydrophobicity (see Wenzel formula). That is, when a surface of the white cured film is highly hydrophobic, adhesion between the white cured film and the second ink cured film is not simply increased by the anchor effect if the surface of the white cured film is rougher, but is also influenced by repellency due to reduction of wettability.

Here, when an actinic ray curable gel ink containing titanium oxide as a pigment for a white ink is used as described above, a hydrophobic gelling agent repels hydrophilic titanium oxide, and the gelling agent is likely to be deposited on the surface of the white cured film because titanium oxide is more hydrophilic than other pigments. In addition, a colored pigment generally acts as a crystal nucleating agent for a gelling agent and reduces the crystal size of the gelling agent. Meanwhile, titanium oxide has a weak interaction with the gelling agent, and does not easily function as a crystal nucleating agent for the gelling agent. The white ink containing titanium oxide tends to increase the crystal size of the gelling agent deposited. As a result, a surface of the white cured film obtained by curing the white ink containing titanium oxide and the gelling agent becomes more hydrophobic because of an increase in the amount of the hydrophobic gelling agent, and becomes rougher because of an increase in the crystal size of the gelling agent. Therefore, it is considered that the lotus effect is easily exhibited.

As described above, it is considered that when titanium oxide is used as a pigment, adhesion between the white ink cured film and the second ink cured film may be deteriorated due to the lotus effect.

In contrast, in the present invention, as described above, by setting the arithmetic average height Sa of the surface of the white cured film to 0.05 μm or more and 0.30 μm or less, repellency of the second ink due to the lotus effect is suppressed while adhesion between the white cured film and the second ink cured film due to the anchor effect is ensured. As a result, it is considered that good adhesion can be obtained between the white cured film and the second ink cured film.

Note that the arithmetic average height Sa of the surface of the white cured film is measured on the basis of a three-dimensional parameter of the shape of the white cured film in accordance with ISO25178-2. The three-dimensional parameter is information representing the shape of an object obtained by scanning an image surface with a laser or the like, and a measurement method may be a contact type or a non-contact type.

In an embodiment of the present invention, a single dot is observed with a laser microscope or the like, an area of a reference length of 20 μm is set within an area of 20 μm×20 μm at a center of the dot, and height data in the area is measured. Sa in the above area can be calculated from the height data measured. Note that for the height data, a noise, undulation, or the like is preferably corrected appropriately with a low-pass filter (S-filter) and a high-pass filter (L-filter) before Sa is calculated.

At this time, the Sa average value obtained by setting an area of a reference length of 20 μm for each of a plurality of dots and measuring heights of the plurality of dots is preferably 0.05 μm or more and 0.30 μm or less. For example, the Sa average value measured from an area of a reference length of 20 μm at ten positions arbitrarily selected on surfaces of 10 dots is preferably 0.05 μm or more and 0.30 μm or less.

1. First Image Forming Step

In the first image forming step, an inkjet actinic ray curable white ink containing an actinic ray polymerizable compound, a gelling agent, and titanium oxide is discharged from a nozzle of an inkjet head and attached onto a recording medium to form a white image.

1-1. White Ink

The actinic ray curable white ink used in the first image forming step is an actinic ray curable white ink (hereinafter, also simply referred to as “white ink”) containing titanium oxide as a pigment, an actinic ray polymerizable compound, and a gelling agent. The white ink may contain a polymerization initiator, a surfactant, and a polymerization inhibitor. Hereinafter, the white ink according to an embodiment of the present invention will be described through detailed description of each component.

1-1-1. Pigment

The white ink according to an embodiment of the present invention contains titanium oxide as a pigment. The white ink according to an embodiment of the present invention contains the titanium oxide preferably in a content of 5% by mass or more and 30% by mass or less, more preferably in a content of 8% by mass or more and 20% by mass or less, still more preferably in a content of 5% by mass or more and 15% by mass or less with respect to the total mass of the white ink.

Examples of a crystal form of titanium oxide that can be used as the white pigment include a rutile type, an anatase type, and a blue kite type. The anatase type is preferable from viewpoints of low specific gravity and easy reduction in particle size, and the rutile type is preferable from viewpoints of a large refractive index in a visible light region and high concealability. For the white ink according to an embodiment of the present invention, one type of titanium oxide selected from titanium oxides having the above crystal forms may be used, or titanium oxides having different crystal forms may be used in combination.

The weight average particle diameter of the titanium oxide is preferably 50 nm or more and 500 nm or less, and more preferably 100 nm or more and 300 nm or less. By setting the weight average particle diameter of titanium oxide to 50 nm or more, an ink having sufficient concealability can be obtained. Meanwhile, by setting the weight average particle diameter of titanium oxide to 500 nm or less, titanium oxide can be stably dispersed, and storage stability and ejection stability of an ink can be improved.

In the present invention, commercially available titanium oxide may be used. Examples of the commercially available titanium oxide that can be used in the present invention include CR-EL, CR-50, CR-80, CR-90, R-780, and R-930 (all manufactured by Ishihara Sangyo Co., Ltd.), TCR-52, R-310, and R-32 (all manufactured by Sakai Chemical Industry Co., Ltd.), and KR-310, KR-380, and KR-380N (all manufactured by Titanium Industry Co., Ltd.).

1-1-2. Actinic Ray Polymerizable Compound

The white ink contains an actinic ray polymerizable compound. The actinic ray polymerizable compound is crosslinked or polymerized by irradiation with an actinic ray. Examples of the actinic ray include an electron beam, an ultraviolet ray, an a ray, a y ray, and an X-ray. Among the actinic rays, the ultraviolet ray or the electron beam is preferable.

The content of the actinic ray polymerizable compound is, for example, preferably 1.0% by mass or more and 97% by mass or less, and more preferably 30% by mass or more and 90% by mass or less with respect to the total mass of the white ink.

Examples of the actinic ray polymerizable compound that is crosslinked or polymerized by irradiation with the actinic ray include a radically polymerizable compound, a cationically polymerizable compound, and a mixture thereof. Among the actinic ray polymerizable compounds, the radically polymerizable compound is preferable. Only one type or two or more types of radically polymerizable compounds may be contained in the white ink. Note that the radically polymerizable compound may be a monomer, a polymerizable oligomer, a prepolymer, or a mixture thereof.

Here, the radically polymerizable compound has an ethylenically unsaturated double bond group in a molecule thereof. The radically polymerizable compound can be a monofunctional monomer or a polyfunctional monomer. Examples of the radically polymerizable compound include a (meth)acrylate that is an unsaturated carboxylate compound. Note that in the present invention, “(meth)acrylate” means an acrylate or a methacrylate, “(meth)acryloyl group” means an acryloyl group or a methacryloyl group, and “(meth)acrylic” means acrylic or methacrylic.

Examples of a monofunctional (meth)acrylate include isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, 2-(meth)acryloyloxyethyl hexahydrophthalic acid, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, 2-(meth)acryloyloxyethyl succinic acid, 2-(meth)acryloyloxyethyl phthalic acid, 2-(meth)acryloyloxyethyl-2-hydroxyethyl-phthalic acid, and t-butylcyclohexyl (meth)acrylate.

Examples of a polyfunctional (meth)acrylate include: a bifunctional (meth)acrylate such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, PO adduct of bisphenol A di(meth)acrylate, hydroxypivalate neopentyl glycol di(meth)acrylate, polytetramethylene glycol di(meth)acrylate, polyethylene glycol diacrylate, or tripropylene glycol diacrylate; a trifunctional (meth)acrylate such as trimethylolpropane tri(meth)acrylate or pentaerythritol tri(meth)acrylate; a tri- or higher functional (meth)acrylate such as pentaerythritol tetra(meth)acrylate, dipentaerythritol hexa(meth)acrylate, ditrimethylolpropane tetra(meth)acrylate, glycerine propoxy tri(meth)acrylate, or pentaerythritol ethoxy tetra(meth)acrylate; a (meth)acryloyl group-containing oligomer including a polyester acrylate oligomer; and modified products thereof. Examples of the modified products include an ethylene oxide-modified (EO-modified) acrylate having an ethylene oxide group inserted thereinto, and a propylene oxide-modified (PO-modified) acrylate having propylene oxide inserted thereinto.

At least a part of the radically polymerizable compound used in the present invention is preferably an ethylene oxide-modified (meth)acrylate compound. This is because the ethylene oxide-modified (meth)acrylate compound has high photosensitivity and easily forms a card house structure when an ink becomes gel at a low temperature. In addition, the ethylene oxide-modified (meth)acrylate compound is easily dissolved in another ink component at a high temperature and has little curing shrinkage, and therefore hardly causes curling of a printed matter.

The cationically polymerizable compound has a cationically polymerizable group. Examples of the cationically polymerizable compound include an epoxy compound, a vinyl ether compound, and an oxetane compound.

Examples of the epoxy compound include: an alicyclic epoxy resin such as 3,4-epoxycyclohexylmethyl-3′,4′-epoxycyclohexane carboxylate, bis(3,4-epoxycyclohexylmethyl) adipate, vinylcyclohexene monoepoxide, ε-caprolactone modified 3,4-epoxycyclohexylmethyl 3′,4′-epoxycyclohexane carboxylate, 1-methyl-4-(2-methyloxiranyl)-7-oxabicyclo [4,1,0]heptane, 2-(3,4-epoxycyclohexyl-5,5-spiro-3,4-epoxy) cyclohexanone-meta-dioxane, or bis(2,3-epoxycyclopentyl) ether; an aliphatic epoxy compound such as a polyglycidyl ether of polyether polyol, obtained by adding one or more alkylene oxides (for example, ethylene oxide and propylene oxide) to an aliphatic polyhydric alcohol such as a diglycidyl ether of 1,4-butanediol, a diglycidyl ether of 1,6-hexanediol, a triglycidyl ether of glycerin, a triglycidyl ether of trimethylolpropane, a diglycidyl ether of polyethylene glycol, a diglycidyl ether of propylene glycol, ethylene glycol, propylene glycol, or glycerin; and an aromatic epoxy compound including a di- or polyglycidyl ether of bisphenol A or an alkylene oxide adduct thereof, a di- or polyglycidyl ether of hydrogenated bisphenol A or an alkylene oxide adduct thereof, and a novolac epoxy resin.

Examples of the vinyl ether compound include: a monovinyl ether compound such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexane dimethanol monovinyl ether, n-propyl vinyl ether, isopropyl vinyl ether, isopropenyl ether-o-propylene carbonate, dodecyl vinyl ether, diethylene glycol monovinyl ether, or octadecyl vinyl ether; and a di- or tri-vinyl ether compound such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexane dimethanol divinyl ether, or trimethylolpropane trivinyl ether.

Examples of the oxetane compound include 3-hydroxymethyl-3-methyloxetane, 3-hydroxymethyl-3-ethyl oxetane, 3-hydroxymethyl-3-propyl oxetane, 3-hydroxymethyl-3-normalbutyl oxetane, 3-hydroxymethyl-3-phenyloxetane, 3-hydroxymethyl-3-benzyloxetane, 3-hydroxyethyl-3-methyloxetane, 3-hydroxyethyl-3-ethyloxetane, 3-hydroxyethyl-3-propyloxetane, 3-hydroxyethyl-3-phenyloxetane, 3-hydroxypropyl-3-methyloxetane, 3-hydroxypropyl-3-ethyloxetane, 3-hydroxypropyl-3-propyloxetane, 3-hydroxypropyl-3-phenyloxetane, 3-hydroxybutyl-3-methyloxetane, 1,4 bis{[(3-ethyl-3-oxetanyl) methoxy] methyl} benzene, 3-ethyl-3-(2-ethylhexyloxymethyl) oxetane, and di[1-ethyl (3-oxetanyl)] methyl ether.

The actinic ray polymerizable compound used in the present invention includes a polyfunctional actinic ray polymerizable compound and may include a monofunctional actinic ray polymerizable compound. However, the content of the monofunctional actinic ray polymerizable compound is preferably 0% by mass or more and 20% by mass or less, and more preferably 0% by mass or more and 10% by mass or less with respect to the total mass of the white ink. When the content of the monofunctional actinic ray polymerizable compound is 20% by mass or less with respect to the total mass of the white ink, the polyfunctional actinic ray polymerizable compound is polymerized and crosslinked to generate a denser network-like hydrocarbon chain. Therefore, the unreacted actinic ray polymerizable compound or the like passes through a gap of the network-like hydrocarbon chain, and odor generated from a cured film can be thereby further reduced.

1-1-3. Polymerization Initiator

The white ink may further contain a polymerization initiator as necessary.

The content of the polymerization initiator can be arbitrarily set within a range in which the white ink is sufficiently cured by irradiation with an actinic ray and dischargeability of the ink is not lowered. For example, the content of the polymerization initiator is preferably 0.1% by mass or more and 20% by mass or less, and more preferably 1.0% by mass or more and 12% by mass or less with respect to the total mass of the white ink.

The polymerization initiator is not particularly limited as long as being able to initiate polymerization of the actinic ray polymerizable compound. For example, when the white ink contains a radically polymerizable compound, the polymerization initiator can be a photoradical initiator, and when the white ink contains a cationically polymerizable compound, the polymerization initiator can be a photocationic initiator (photoacid generator). Note that when the white ink can be sufficiently cured without the polymerization initiator, for example, when the white ink is cured by irradiation with an electron beam, the polymerization initiator is unnecessary.

The radical polymerization initiator includes an intramolecular bond cleavage type radical polymerization initiator and an intramolecular hydrogen abstraction type radical polymerization initiator.

Examples of the intramolecular bond cleavage type radical polymerization initiator include: an acetophenone-based initiator including diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-hydroxyethoxy) phenyl-(2-hydroxy-2-propyl) ketone, 1-hydroxycyclohexyl-phenyl ketone, 2-methyl-2-morpholino (4-methylthiophenyl) propan-1-one, and 2-benzyl-2-dimethylamino-1-(4-morpholinophenyl)-butanone; a benzoin including benzoin, benzoin methyl ether, and benzoin isopropyl ether; an acylphosphine oxide-based initiator including 2,4,6-trimethylbenzoin diphenylphosphine oxide; benzyl; and a methylphenyl glyoxy ester.

Examples of the intramolecular hydrogen abstraction type radical polymerization initiator include: a benzophenone-based initiator including benzophenon, methyl o-benzoylbenzoate-4-phenylbenzophenone, 4,4′-dichlorobenzophenone, hydroxybenzophenone, 4-benzoyl-4′-methyl-diphenylsulfide, acrylated benzophenone, 3,3′,4,4′-tetra(t-butylperoxycarbonyl) benzophenone, and 3,3′-dimethyl-4-methoxybenzophenone; a thioxanthone-based initiator including 2-isopropylthioxanthone, 2,4-dimethylthioxanthone, 2,4-diethylthioxanthone, and 2,4-dichlorothioxanthone; an aminobenzophenone-based initiator including Michler's ketone and 4,4′-diethylaminobenzophenone; 10-butyl-2-chloroacridone; 2-ethylanthraquinone; 9,10-phenanthrenequinone; and camphorquinone.

Examples of the cationic polymerization initiator include a photoacid generator. Examples of the photoacid generator include a sulfonate that generates a sulfonic acid, a halide that generates a hydrogen halide with light, and an iron allene complex, such as a B(C₆F₅)₄⁻ salt, a PF₆⁻ salt, an AsF₆⁻ salt, a SbF₆⁻ salt, or a CF₃SO₃⁻ salt of an aromatic onium compound including diazonium, ammonium, iodonium, sulfonium, and phosphonium.

1-1-4. Gelling Agent

The white ink contains a gelling agent. The gelling agent is an organic substance that is solid at room temperature but becomes liquid by being heated and can cause the white ink to undergo sol-gel phase transition in response to a temperature change.

The content of the gelling agent is preferably 0.3% by mass or more and 8.0% by mass or less, more preferably 0.5% by mass or more and 5% by mass or less, and still more preferably 0.8% by mass or more and 3.5% by mass or less with respect to the total mass of the white ink.

As the content of the gelling agent is smaller, the amount of the crystal of the gelling agent deposited on a surface of the white cured film is also smaller, and therefore the roughness of the surface of the white cured film can be further reduced. The content of the gelling agent is preferably 0.3% by mass or more and 2.0% by mass or less with respect to the total mass of the white ink from the above viewpoint.

The gelling agent is preferably crystallized in the ink at a temperature equal to or lower than the gelation temperature of the ink. Here, the gelation temperature refers to a temperature at which an ink that has become sol or liquid by being heated undergoes a phase transition from sol to gel to rapidly change the viscosity of the ink when the ink is cooled. Specifically, the gelation temperature of an ink that has become sol or liquid can be a temperature at which the viscosity of the ink is rapidly increased when the ink is cooled with the viscosity measured using a rheometer MCR300 (manufactured by Anton Paar GmbH).

In order to stably discharge ink droplets from an inkjet recording device, compatibility between the radically polymerizable compound and the gelling agent needs to be good in a sol-like ink (at a high temperature, for example, about 80° C.).

When the gelling agent is crystallized in the ink, a structure in which an actinic ray polymerizable compound is encapsulated in a three-dimensional space formed by the gelling agent crystallized in a plate shape may be formed (such a structure is hereinafter referred to as a “card house structure”). When the card house structure is formed, the liquid actinic ray polymerizable compound is held in the space. Therefore, dots formed by attachment of the ink are less likely to cause wet spreading, and a pinning property of the ink is further enhanced. When the pinning property of the ink is increased, coalescence of the dots formed by attachment of the ink to the recording medium is difficult.

When the white ink contains a gelling agent, the crystal of the gelling agent is deposited on a surface of the white cured film formed after the first exposure step described later. The deposited crystal of the gelling agent typically has a hydrocarbon chain with a certain length, and therefore has a high affinity with a hydrocarbon chain formed by polymerization and crosslinking of the actinic ray polymerizable compound in a second ink cured product. In addition, after the second ink is cured, the crystal of the gelling agent contained in the second ink is deposited at an interface with the white cured film in the second ink cured product. The crystal of the gelling agent deposited on the surface of the white cured film also has a high affinity with the crystal of the gelling agent deposited from the second ink cured product. Therefore, the gelling agent can cause an interaction between the second ink cured product and the white cured film, and can further improve adhesion between the second ink cured product and the white cured film.

Examples of the gelling agent suitable for formation of the card house structure include an aliphatic ketone compound, an aliphatic ester compound, a fatty acid amide, an N-substituted fatty acid amide, a special fatty acid amide, and a higher amine.

The gelling agent preferably contains a linear or branched hydrocarbon group having 9 to 25 carbon atoms from a viewpoint of easily forming the above-described “card house structure”.

Among these compounds, an aliphatic ketone having a structure represented by the following general formula (G1) and an aliphatic ester having a structure represented by the following general formula (G2) are particularly preferable.

R₁—CO—R₂ General formula (G1):

R₃—COO—R₄ General formula (G2):

In the general formulas (G1) and (G2), R₁ to R₄ each independently represent a linear or branched hydrocarbon group having 9 to 25 carbon atoms. The hydrocarbon group is preferably an alkyl group.

In general formula (G1), each of the hydrocarbon groups represented by R₁ and R₂ is not particularly limited, but is preferably a linear or branched hydrocarbon group having 9 to 25 carbon atoms, and more preferably a linear or branched hydrocarbon group having 12 to 25 carbon atoms. The hydrocarbon group having 9 to 25 carbon atoms and the hydrocarbon group having 12 to 25 carbon atoms are more preferably linear or branched alkyl groups.

Examples of the aliphatic ketone compound represented by the general formula (G1) include 18-pentatriacontanone (C17-C17), dilignoceryl ketone (C24-C24), dibehenyl ketone (C22-C22), distearyl ketone (C18-C18), dieicosyl ketone (C20-C20), dipalmityl ketone (C16-C16), dimyristyl ketone (C14-C14), dilauryl ketone (C12-C12), lauryl myristyl ketone (C12-C14), lauryl palmityl ketone (C12-C16), myristyl palmityl ketone (C14-C16), myristyl stearyl ketone (C14-C18), myristyl behenyl ketone (C14-C22), palmityl stearyl ketone (C16-C18), palmityl behenyl ketone (C16-C22), and stearyl behenyl ketone (C18-C22). Note that the carbon numbers in the parenthesis represent the carbon numbers of two hydrocarbon groups divided by a carbonyl group.

Examples of a commercially available product of the compound represented by general formula (G1) include 18-Pentatriacontanon (manufactured by Alfa Aeser), Hentriacontan-16-on (manufactured by Alfa Aeser), and Kaowax T1 (manufactured by Kao Corporation). Only one type of aliphatic ketone compound or a mixture of two or more types thereof may be contained in the ink.

In general formula (G2), each of the hydrocarbon groups represented by R₃ and R₄ is not particularly limited, but is preferably a linear or branched hydrocarbon group having 9 to 25 carbon atoms, and more preferably a linear or branched hydrocarbon group having 12 to 25 carbon atoms. The hydrocarbon group having 9 to 25 carbon atoms and the hydrocarbon group having 12 to 25 carbon atoms are more preferably linear or branched alkyl groups.

Examples of the aliphatic ester compound represented by general formula (G2) include behenyl behenate (C21-C22), icosyl icosylate (C19-C20), stearyl stearate (C17-C18), palmityl stearate (C17-C16), lauryl stearate (C17-C12), cetyl palmitate (C15-C16), stearyl palmitate (C15-C18), myristyl myristate (C13-C14), cetyl myristate (C13-C16), octyldodecyl myristate (C13-C20), stearyl oleate (C17-C18), stearyl erucate (C21-C18), stearyl linoleate (C17-C18), behenyl oleate (C18-C22), myricyl cellotate (C25-C16), and arachidyl linoleate (C17-C20). Note that the carbon numbers in the parenthesis represent the carbon numbers of two hydrocarbon groups divided by an ester group.

Examples of a commercially available product of the aliphatic ester compounds represented by general formula (G2) include UNISTAR M-2222SL (manufactured by NOF Corporation), UNISTAR M-9796 (manufactured by NOF Corporation), EXCEPARL SS (manufactured by Kao Corporation), EMALEX CC-18 (manufactured by Nihon Emulsion Co., Ltd.), AMREPS PC (manufactured by Kokyu Alcohol Kogyo Co., Ltd.), EXCEPARL MY-M (manufactured by Kao Co., Ltd.), Spermaceti (manufactured by NOF Corporation), and EMALEX CC-10 (manufactured by Nihon Emulsion Co., Ltd.). These commercially available products are often used as a mixture of two or more types thereof, and therefore may be separated and purified as necessary.

Note that examples of the fatty acid amide include lauric acid amide, stearic acid amide, behenic acid amide, oleic acid amide, erucic acid amide, ricinoleic acid amide, and 12-hydroxystearic acid amide (for example, Nikka Amide series manufactured by Nihon Kasei Co., Ltd.), ITOWAX series manufactured by Itoh Oil Chemicals Co., Ltd., and FATTY AMIDE series manufactured by Kao Corporation).

Examples of the N-substituted fatty acid amide include N-stearyl stearic acid amide and N-oleyl palmitic acid amide.

Examples of the special fatty acid amide include N,N′-ethylenebisstearylamide, N,N′-ethylenebis-12-hydroxystearylamide, and N,N′-xylylenebisstearylamide.

Examples of the higher amine include dodecylamine, tetradecylamine, and octadecylamine

The gelling agent contained in the ink may be a mixture of two or more types thereof.

1-1-5. Crystal Nucleating Agent

The white ink may contain a crystal nucleating agent.

Examples of the crystal nucleating agent include a (poly)glycerin fatty acid ester compound having a (poly)glycerin skeleton and an alkyl group having 15 or more carbon atoms bonded to the (poly)glycerin skeleton.

The (poly)glycerin fatty acid ester compound forms a micelle-like structure with an alkyl group directed to the outside because the glycerin structures contained in the structure of the (poly)glycerin fatty acid ester compound strongly interact with each other in an organic solvent. In addition, the alkyl group directed to the outside interacts with a carbon chain of the gelling agent. Therefore, it is considered that the (poly)glycerin fatty acid ester compound serves as a starting point for crystallization of the gelling agent and promotes crystal nucleation. At this time, since the nucleation rate of the gelling agent is high in the system, the crystal growth of the gelling agent is suppressed, and the crystal size of the gelling agent is reduced. As a result, the roughness of the surface of the white cured film due to the crystal of the gelling agent is reduced, and wetting of the second ink on a surface of the white cured film is improved.

(Poly)glycerin refers to glycerin or polyglycerin, and polyglycerin refers to a compound having a structure in which a plurality of glycerins is polymerized. Polyglycerin in which two glycerin are bonded is also referred to as diglycerin, polyglycerin in which three glycerins are bonded is also referred to as triglycerin, and polyglycerin in which ten glycerins are bonded is also referred to as decaglycerin.

Examples of the (poly)glycerin fatty acid ester compound include tetraglycerin tristearate, hexaglycerin tristearate, decaglycerin tristearate, and decaglycerin tristearate heptabehenate.

The content of the crystal nucleating agent is preferably 1.0% by mass or more and 80% by mass or less, and more preferably 10% by mass or more and 40% by mass or less with respect to the total mass of the gelling agent. When the content is 1.0% by mass or more, the crystal nucleating agent sufficiently acts as a crystal nucleus for the gelling agent, and can appropriately suppress the surface roughness of the white cured film. When the content is 80% by mass or less, crystal nucleation is unlikely to be excessive, and the gelling agent can sufficiently form the card house structure to suppress a decrease in a pinning property of the ink.

At this time, when the carbon number of an alkyl group of the (poly)glycerin fatty acid ester compound is 15 or more, the interaction with the gelling agent is more likely to occur. Therefore, an increase in size of the crystal of the gelling agent is easily suppressed, and wetting of the second ink on the surface of the white cured film tends to increase. The number of carbon atoms of the alkyl group is not particularly limited, but is preferably 40 or less, and more preferably 30 or less from a viewpoint of discharge stability.

The alkyl group of the (poly)glycerin fatty acid ester compound only needs to contain a linear portion having 15 or more carbon atoms. Examples of the alkyl group containing a linear portion having 15 or more carbon atoms include a docosanyl group (C22), an icosanyl group (C20), an octadecanyl group (C18), a heptadecanyl group (C17), a hexadecanyl group (C16), and a pentadecanyl group (C15).

The length of the linear portion in the alkyl group of the (poly)glycerin fatty acid ester compound is preferably similar to that of the gelling agent. Specifically, the number of carbon atoms of the linear portion in at least one of the alkyl groups of the (poly)glycerin fatty acid ester compound preferably has a difference of 2 or less from the number of carbon atoms of the linear portion in at least one of the alkyl groups of the gelling agent. When the difference in the number of carbon atoms between the alkyl groups is 2 or less, the interaction between the crystal nucleating agent and the gelling agent is further enhanced, the crystal nucleation by the gelling agent is promoted, and excessive coarsening of the surface of the white cured film is suppressed. Therefore, the second ink is more easily wetted on the white cured film, and adhesion between the white cured film and the second ink cured film is further increased.

1-1-6. Crystal Growth Inhibitor

The white ink may contain a crystal growth inhibitor.

The crystal growth inhibitor is a compound having an alkyl chain containing a linear portion having 15 or more carbon atoms. The alkyl chain of the crystal growth inhibitor is likely to interact with the alkyl chain of the gelling agent. Therefore, the crystal growth inhibitor can be adsorbed by a crystal growth surface of the gelling agent, and can suppress the crystal growth of the gelling agent. In this way, the crystal size of the gelling agent is reduced. As a result, the surface roughness (arithmetic average height Sa) of a coating film surface resulting from the crystal of the gelling agent is reduced, and wetting of the second ink to the white cured film is improved.

The content of the crystal growth inhibitor contained in the white ink is preferably 1.0% by mass or more and 80% by mass or less with respect to the total mass of the gelling agent. When the content is 1.0% by mass or more, the crystal growth inhibitor can sufficiently inhibit the crystal growth of the gelling agent, and can appropriately suppress the surface roughness of the white cured film. When the content is 80% by mass or less, excessive suppression of the crystal is unlikely to occur, and the gelling agent can sufficiently form the card house structure to suppress a decrease in a pinning property of the ink.

The alkyl group of the crystal growth inhibitor only needs to contain a linear portion having 15 or more carbon atoms. Examples of the alkyl group containing a linear portion having 15 or more carbon atoms include a docosanyl group (C22), an icosanyl group (C20), an octadecanyl group (C18), a heptadecanyl group (C17), a hexadecanyl group (C16), and a pentadecanyl group (C15).

Examples of the crystal growth inhibitor include: a petroleum-based wax such as a paraffin wax, a microcrystalline wax, or petrolactam; a plant-based wax such as a candelilla wax, a carnauba wax, a rice wax, a wood wax, a jojoba oil, a jojoba solid wax, or a jojoba ester; an animal-based wax such as a beeswax, lanolin, or a whale wax; a mineral-based wax such as a montan wax or a hydrogenated wax; a hardened castor oil or a hardened castor oil derivative; a modified wax such as a montan wax derivative, a paraffin wax derivative, a microcrystalline wax derivative, or a polyethylene wax derivative; a higher fatty acid such as behenic acid, arachidic acid, stearic acid, palmitic acid, myristic acid, lauric acid, oleic acid, or erucic acid; a higher alcohol such as stearyl alcohol or behenyl alcohol; a hydroxystearic acid such as 12-hydroxystearic acid; and a 12-hydroxystearic acid derivative.

1-1-7. Polymerization Inhibitor

The white ink may contain a polymerization inhibitor.

Examples of the polymerization inhibitor include (alkyl) phenol, hydroquinone, catechol, resorcin, p-methoxyphenol, t-butylcatechol, t-butylhydroquinone, pyrogallol, 1,1-picrylhydrazyl, phenothiazine, p-benzoquinone, nitrosobenzene, 2,5-di-t-butyl-p-benzoquinone, dithiobenzoyl disulfide, picric acid, cupferron, aluminum N-nitrosophenylhydroxylamine, tri-p-nitrophenylmethyl, N-(3-oxyanilino-1,3-dimethylbutylidene) aniline oxide, dibutyl cresol, cyclohexanone oxime cresol, guaiacol, o-isopropyl phenol, butyral doxime, methylethyl ketoxime, and cyclohexanone oxime.

1-1-8. Other Components

The white ink may further contain other components as necessary. The other components may be various additives, other resins, and the like. Examples of the additives include a surfactant, a leveling additive, a matting agent, an infrared absorber, an antibacterial agent, and a basic compound for enhancing storage stability of the ink. Examples of the basic compound include a basic alkali metal compound, a basic alkaline earth metal compound, and a basic organic compound such as an amine Examples of the other resins include a resin for adjusting physical properties of the cured film, such as a polyester-based resin, a polyurethane-based resin, a vinyl-based resin, an acrylic resin, or a rubber-based resin.

The white ink may be combined with an actinic ray curable ink described later to form an ink set. The second ink used in the ink set is not particularly limited, and an appropriate ink can be selected according to a target image.

1-1-9. Physical Properties of Ink

As described above, the white ink contains a gelling agent. Therefore, the white ink can reversibly undergo a sol-gel phase transition depending on temperature. In general, a sol-gel phase transition type actinic ray curable ink is sol at a high temperature (for example, about 80° C.) and therefore can be discharged from an inkjet head. However, the ink is naturally cooled and becomes gel after being attached to a recording medium. As a result, coalescence of adjacent dots can be suppressed, and image quality can be improved.

When the white ink contains the gelling agent, the viscosity of the ink at a high temperature is preferably a certain value or less in order to improve an ejection property of the white ink. Specifically, the viscosity of the ink at 80° C. is preferably 3 to 20 mPa·s, more preferably 6.0 to 15.0 mPa·s, and still more preferably 7.0 to 12.0 mPa·s. Meanwhile, in order to suppress coalescence of adjacent dots, the viscosity of the ink at room temperature after attachment is preferably a certain value or more. Specifically, the viscosity of the white ink at 25° C. is preferably 1000 mPa·s or more.

When the white ink contains the gelling agent, the gelation temperature is preferably 40° C. or higher and 70° C. or lower, and more preferably 50° C. or higher and 65° C. or lower. When the ejection temperature is around 80° C. and the gelation temperature of the ink exceeds 70° C., gelation is likely to occur at the time of ejection, and therefore an ejection property is lowered. Meanwhile, when the gelation temperature is lower than 40° C., the ink does not become gel immediately after being attached to a recording medium. The gelation temperature is a temperature at which fluidity decreases due to gelation in a process of cooling an ink in a sol state.

The viscosity of the white ink at 80° C., and the viscosity and the gelation temperature thereof at 25° C. can be determined by measuring a temperature change of dynamic viscoelasticity of the ink with a rheometer. Specifically, a temperature change curve of viscosity is obtained when the ink is heated to 100° C. and cooled to 25° C. under a condition where a shear rate is 11.7 (1/s) and a temperature falling rate is 0.1° C./s. The viscosity at 80° C. and the viscosity at 25° C. can be determined by reading the viscosity at 80° C. and the viscosity at 25° C. in the temperature change curve of viscosity, respectively. The gelation temperature can be determined as a temperature at which the viscosity is 200 mPa·s in the temperature change curve of viscosity.

As the rheometer, a stress-controlled rheometer (Physica MCR series) manufactured by Anton Paar GmbH can be used. A cone plate can have a diameter of 75 mm, and a cone angle can be 1.0°.

1-1-10. Preparation of White Ink

The white ink can be prepared by mixing the above-described titanium oxide, actinic ray polymerizable compound, gelling agent, and other components under heating. The obtained liquid mixture is preferably filtered with a predetermined filter. At this time, a dispersion containing the white pigment and the surfactant may be prepared in advance, and the remaining components may be added thereto and mixed while heating.

1-2. Discharge and Attachment of White Ink

In the first image forming step according to an embodiment of the present invention, the white ink is discharged from a nozzle of an inkjet head and attached to a surface of a recording medium. Hereinafter, the first image forming step will be described.

In the step of discharging the white ink from an inkjet head and attaching the white ink onto a recording medium, by setting the temperature of the white ink in the inkjet head to a temperature that is higher than the gelation temperature of the ink by 10 to 30° C., dischargeability of ink droplets can be improved. By setting the temperature of the white ink in the inkjet head to a temperature that is higher than the gelation temperature by 10° C. or more, gelation of the ink in the inkjet head or on a nozzle surface is suppressed, and discharge of ink droplets is easily stabilized. Meanwhile, by not setting the temperature of the white ink in the inkjet head to a temperature that is higher than the gelation temperature by more than 30° C., it is possible to prevent deterioration of the ink components due to the high temperature of the ink. The ink can be heated by an inkjet head of an image forming apparatus, an ink channel connected to the inkjet head, an ink tank connected to the ink channel, and the like.

The temperature of the recording medium when the ink droplets are attached to the recording medium is preferably set to a temperature that is lower than the gelation temperature of the ink by 10 to 20° C. When the temperature of the recording medium is too low, the ink droplets become gel too quickly to be pinned. Meanwhile, when the temperature of the recording medium is too high, gelation of the ink droplets is unlikely to occur, and adjacent droplets may be mixed with each other. By appropriately adjusting the temperature of the recording medium, it is possible to achieve both appropriate leveling and appropriate pinning such that adjacent droplets are not mixed with each other.

The amount of one droplet discharged from a nozzle of the inkjet head depends on the resolution of an image, but is preferably within a range of 0.5 to 10 pL, and more preferably within a range of 0.5 to 4.0 pL in order to form a high-definition image. In order to form a high-definition image with such a droplet amount, it is necessary for the ink droplets after attachment to the recording medium not to coalesce with each other, that is, it is necessary for the ink to sufficiently undergo sol-gel phase transition. In the white ink, sol-gel transition is rapidly performed. Therefore, a high-definition image can be stably formed even with such a droplet amount.

The ink droplets attached to the recording medium are cooled and rapidly become gel by sol-gel phase transition. As a result, the ink droplets can be pinned without being diffused. In addition, oxygen does not easily enter the ink droplets, and therefore curing of the actinic ray polymerizable compound is hardly inhibited by oxygen.

The white ink is preferably attached such that the total ink droplet thickness after curing is within a range of 1 to 20 μm. Here, the “total ink droplet thickness” means the maximum thickness of the white cured film obtained by curing the white ink drawn on the recording medium.

The amount of the white ink attached is preferably within a range of 0.6 to 1.6 g/m² in terms of titanium oxide from a viewpoint of achieving improved concealability, improved curability, and curl suppression

The first image forming step may be performed by either a single pass method or a scan method, but the image forming speed can be increased by adopting the single pass method.

Examples of the recording medium include: an absorbable medium including coated paper including art paper, coated paper, lightweight coated paper, finely coated paper, cast paper, corrugated paper, and vapor-deposited paper obtained by depositing a vapor-deposited film of a metal such as aluminum, and non-coated paper; a nonabsorbable recording medium (plastic substrate) formed of a plastic such as polyester, polyvinyl chloride, polyethylene, polyurethane, polypropylene, an acrylic resin, polycarbonate, polystyrene, an acrylonitrile-butadiene-styrene copolymer, polyethylene terephthalate, or polybutadiene terephthalate; and a nonabsorbable inorganic recording medium such as a metal or glass. Note that the recording medium can be appropriately selected according to a purpose.

A conveying speed of the recording medium is not particularly limited, and can be set, for example, between 1 and 120 m/s. The higher the conveying speed, the faster the image forming speed.

2. First Exposure Step

The first exposure step according to an embodiment of the present invention is performed after the first image forming step. In the first exposure step, the white ink attached to a first image forming surface side of the recording medium (front surface side of the recording medium) is irradiated with an actinic ray to cure the white ink attached to the first image forming surface side of the recording medium, thus forming a white cured film.

The arithmetic average height Sa of the surface of the white cured film obtained by curing the white ink in the first exposure step (hereinafter, also simply referred to as “white cured film”) is preferably 0.05 μm or more and 0.30 μm or less, and more preferably 0.05 μm or more and 0.20 μm or less from a viewpoint of improving adhesion between the white cured film and the second ink cured film.

It is considered that adhesion between the two films is improved due to the anchor effect when the arithmetic average height Sa on the surface of the white cured film is 0.05 μm or more, and the lotus effect can be suppressed and repellency of the second ink can be suppressed to improve adhesion between the two films when Sa is 0.30 μm or less.

The arithmetic average height Sa on the surface of the white cured film can be adjusted within the above range by appropriately suppressing deposition of the crystal of the gelling agent on the surface of the white cured film. Specifically, the arithmetic average height Sa of the surface of the white cured film can be adjusted within the above range by the content of the gelling agent in the white ink, the content of a crystal nucleating agent in the white ink, the content of a crystal growth inhibitor in the white ink, the oxygen concentration of the atmosphere in the first exposure step, a treatment for smoothing the surface of the white cured film formed, and the like.

2-1. Irradiation with Actinic Ray

The actinic ray with which the white ink attached to a surface of the recording medium is irradiated is preferably an ultraviolet ray from an ultraviolet LED. Examples of a general ultraviolet light source include a metal halide lamp. By using an ultraviolet LED as a light source, it is possible to suppress melting of the ink by radiant heat of the light source, that is, it is possible to suppress occurrence of poor curing on the surface of the cured film of the ink. In a wavelength region of 400 nm or less, the absorption by titanium oxide increases as the wavelength becomes shorter. Therefore, a peak wavelength of the ultraviolet LED is preferably within a range of 385 to 400 nm from a viewpoint of appropriately curing the ink. Examples of the light source having an ultraviolet LED include a water cooling type ultraviolet irradiation unit (peak wavelength: 395 nm) manufactured by Phoseon Technology.

Irradiation conditions of the actinic ray can be appropriately set according to the composition of the ink and the like. For example, the light source having an ultraviolet LED is disposed such that the maximum illuminance on the surface of the white ink attached to the surface of the recording medium is preferably 0.5 to 10.0 W/cm², and more preferably 1.0 to 5.0 W/cm². Note that the thickness of the white ink is within a negligible range for the irradiation with the actinic ray. Therefore, adjustment of the maximum illuminance on the surface of the white ink attached to the surface of the recording medium may be performed by adjustment of the maximum illuminance on the surface of the recording medium.

The first exposure step of curing the inkjet actinic ray curable white ink may be performed under a low oxygen concentration.

It is well known that a curing reaction of a radically polymerizable compound is inhibited by oxygen. For example, when an ink containing a radically polymerizable compound is cured in the atmosphere (under a normal oxygen concentration), radical polymerization on a surface of a coating film is inhibited, and curing is delayed. Meanwhile, when exposure is performed in a low oxygen concentration atmosphere, a radical reaction is hardly inhibited, and curing is accelerated.

Therefore, when the white ink is exposed in a low oxygen concentration atmosphere and the curing speed is increased, the ink can be cured before deposition of the gelling agent on the coating film surface proceeds. As a result, the roughness of the surface of the white cured film can be lower than that of a cured film cured in the atmosphere (under a normal oxygen concentration).

That is, when the white ink coating film is exposed in a low oxygen concentration atmosphere, deposition of the highly hydrophobic gelling agent on the coating film surface can be suppressed, and the roughness of the surface of the white cured film can be reduced. As a result, the lotus effect can be suppressed, and repellency of the second ink on the surface of the white cured film can be suppressed.

The oxygen concentration at the time of exposure is preferably 15% by volume or less, and more preferably 10% by volume or less from a viewpoint of suppressing deposition of the gelling agent on a surface of a coating film to lower the arithmetic average height Sa (surface roughness) of the surface of the white cured film. The lower limit of the oxygen concentration is not particularly limited, but is preferably 0.01% by volume or more, for example.

Examples of a method for forming the low oxygen concentration atmosphere include a method for spraying nitrogen gas or the like on a coating film, a method using a container or a room filled with nitrogen gas, and a method using a sealed decompression container. In particular, the method for reducing the oxygen concentration using nitrogen gas is effective because of simplicity of the method.

3. Step of Smoothing White Cured Film

The image forming method according to an embodiment of the present invention may include a step of smoothing the white cured film (hereinafter, also simply referred to as a smoothing step) between the first exposure step and the second image forming step described below.

In the smoothing step, fine unevenness formed on the surface of the white cured film deriving from the gelling agent is smoothed.

In the smoothing step, by mechanically smoothing the unevenness, the arithmetic average height Sa of the surface of the white cured film can be reduced, the lotus effect can be suppressed, and wettability of the second ink applied to the surface of the white cured film can be improved. Examples of a method for smoothing the white cured film include mechanical smoothing such as pressing or rubbing.

Pressing is preferably performed with a rolling roller or the like in consideration of continuous use in a printing device. A pressure to be applied is preferably 10 kPa or more and 200 kPa or less, and more preferably 20 kPa or more and 100 kPa or less from a viewpoint of adjusting the arithmetic average height Sa (surface roughness) of the surface of the white cured film within the above range. When the pressure is 10 kPa or more, the arithmetic average height of the surface of the white cured film is easily lowered to the above range. When the pressure is 200 kPa or less, a substrate is hardly damaged.

4. Second Image Forming Step

The Second Image Forming Step According to an Embodiment of the Present Invention is Performed after the first exposure step. In the second image forming step, an inkjet actinic ray curable ink containing an actinic ray polymerizable compound is discharged from a nozzle of the inkjet head and attached onto the white cured film formed on a surface of the recording medium. The second ink used in the second image forming step is preferably an ink that can be discharged by inkjet like the white ink used in the first image forming step from a viewpoint of facilitating image formation.

4-1. Second Ink

The actinic ray curable ink used in the second image forming step is an actinic ray curable ink containing an actinic ray polymerizable compound. The second ink may contain a coloring material, a polymerization initiator, a gelling agent, a surfactant, and a polymerization inhibitor. Hereinafter, the white ink according to an embodiment of the present invention will be described through detailed description of each component.

4-1-1. Coloring Material

The second ink preferably contains a coloring material. The coloring material includes a pigment and a dye. The coloring material is preferably a pigment from viewpoints of further improving dispersion stability of the second ink and forming an image having high weather resistance.

Examples of the pigment include the following organic pigments and inorganic pigments described in the color index.

Examples of red and magenta pigments include Pigment Red 3, 5, 19, 22, 31, 38, 43, 48: 1, 48: 2, 48: 3, 48: 4, 48: 5, 49: 1, 53: 1, 57: 1, 57: 2, 58: 4, 63: 1, 81, 81: 1, 81: 2, 81: 3, 81: 4, 88, 104, 108, 112, 122, 123, 144, 146, 149, 166, 168, 169, 170, 177, 178, 179, 184, 185, 208, 216, 226, and 257, Pigment Violet 3, 19, 23, 29, 30, 37, 50, and 88, and Pigment Orange 13, 16, 20, and 36.

Examples of blue and cyan pigments include Pigment Blue 1, 15, 15: 1, 15: 2, 15: 3, 15: 4, 15: 6, 16, 17-1, 22, 27, 28, 29, 36, and 60.

Examples of a green pigment include Pigment Green 7, 26, 36, and 50.

Examples of a yellow pigment include Pigment Yellow 1, 3, 12, 13, 14, 17, 34, 35, 37, 55, 74, 81, 83, 93, 94, 95, 97, 108, 109, 110, 137, 138, 139, 153, 154, 155, 157, 166, 167, 168, 180, 185, and 193.

Examples of a black pigment include Pigment Black 7, 28, and 26.

Examples of the dye include various oil-soluble dyes.

The content of the pigment or the dye is preferably 1% by mass or more and 30% by mass or less, and more preferably 2% by mass or more and 20% by mass or less with respect to the total mass of the second ink. When the content of the pigment or the dye is 2% by mass or more with respect to the total mass of the second ink, the resulting image is sufficiently colored. When the content of the pigment or the dye is 20% by mass or less with respect to the total mass of the second ink, the viscosity of the ink does not increase excessively.

4-1-2. Actinic Ray Polymerizable Compound

The second ink contains an actinic ray polymerizable compound like the white ink used in the first image forming step. As the actinic ray polymerizable compound that can be used in the second image forming step, a similar compound to those exemplified for the actinic ray polymerizable compound that can be contained in the white ink used in the first image forming step can be used.

4-1-3. Polymerization Initiator

As the polymerization initiator that can be contained in second ink in the second image forming step, a similar compound to those exemplified for the polymerization initiator that can be contained in the white ink used in the first image forming step can be used.

4-1-4. Gelling Agent

The second ink may contain a gelling agent. As the gelling agent that can be used in the second image forming step, a similar compound to those exemplified for the gelling agent that can be contained in the white ink used in the first image forming step can be used.

The content of the gelling agent is preferably 0.01% by mass or more and 7.0% by mass or less, more preferably 0.01% by mass or more and 4.0% by mass or less, and still more preferably 1.0% by mass or more and 4.0% by mass or less with respect to the total mass of the second ink.

As described above, when another actinic ray curable ink is applied in contact with the surface of the white cured film, the other actinic ray curable ink is repelled on the surface of the white cured film, resulting in a decrease in adhesion of an image. In contrast, when the actinic ray curable ink contains a gelling agent, a crystal of the gelling agent is deposited at an interface with the white cured film in the second ink cured product. The deposited crystal of the gelling agent typically has a hydrocarbon chain with a certain length, and therefore has a high affinity with a hydrocarbon chain generated by polymerization and crosslinking of the actinic ray polymerizable compound in the white cured film. As a result, the gelling agent can cause an interaction between the second ink cured product and the white cured film, and can improve adhesion between the second ink cured product and the white cured film. Therefore, the curing ratio of the white cured film can be further increased to enhance adhesion between the white cured film and a cured film formed on the white cured film.

By containing the gelling agent, the second ink applied to the surface of the white cured film can be thickened. Also by thickening the second ink, it is considered that repelling of the second ink is prevented on the surface of the white cured film when the ink is attached onto the white cured film, and adhesion between the white cured film and a cured film formed on the white cured film can be enhanced.

4-1-5. Polymerization Inhibitor

The second ink used in the second image forming step may contain a polymerization inhibitor. As the polymerization inhibitor that can be used in the second image forming step, a similar compound to those exemplified for the polymerization inhibitor that can be contained in the white ink used in the first image forming step can be used.

4-1-6. Preparation of Second Ink

The second ink can be prepared by mixing the actinic ray polymerizable compound described above and arbitrary components under heating. The obtained liquid mixture is preferably filtered with a predetermined filter. When the second ink contains a pigment, a dispersion containing the pigment and a dispersant may be prepared in advance, and the remaining components may be added thereto and mixed while heating.

4-1-7. Physical Properties of Second Ink

The viscosity of the second ink is preferably within a range of 1×10⁰ to 1×10³ Pa·s at the temperature of the recording medium when the second ink is attached onto the recording medium. By setting the viscosity of the second ink to 1×10⁰ Pa·s or more, it is possible to suppress coalescence of adjacent droplets after attachment to the recording medium. By setting the viscosity of the second ink to 1×10⁰ Pa·s or less, the droplets are appropriately wet and spread on the substrate, and a high-definition image without a streak-like appearance can be obtained. The viscosity of the second ink can be measured with a rheometer. As the rheometer, a stress-controlled rheometer (PhyMCR series) manufactured by Anton Paar GmbH can be used. A cone plate can have a diameter of 75 mm, and a cone angle can be 1.0°.

Note that when the second ink contains a gelling agent, the viscosity of the ink at 80° C. is preferably 3 to 20 mPa·s, more preferably 6.0 to 15.0 mPa·s, and still more preferably 7.0 to 12.0 mPa·s like the white ink. At this time, the viscosity of the second ink at 25° C. is preferably 1000 mPa·s or more. At this time, the gelation temperature of the second ink is preferably 40° C. or higher and 70° C. or lower, and more preferably 50° C. or higher and 65° C. or lower.

4-2. Discharge and Attachment of Second Ink

In the second image forming step, the second ink is attached onto the white cured film formed on the recording medium through the first image forming step and the first exposure step by an inkjet method, thereby forming an image. At this time, the second ink is overcoated on the white cured film so as to cover a part or the whole of the white cured film obtained by curing the white ink.

When the second ink droplets are discharged from an inkjet head of an image forming apparatus, by setting the temperature of the second ink in the inkjet head to a temperature that is higher than the gelation temperature of the ink by 10 to 30° C., dischargeability of the second ink droplets can be improved. By setting the temperature of the second ink in the inkjet head to a temperature that is higher than the gelation temperature by 10° C. or more, gelation of the second ink in the inkjet head or on a nozzle surface is suppressed, and discharge of the second ink droplets is easily stabilized. Meanwhile, by not setting the temperature of the second ink in the inkjet head to a temperature that is higher than the gelation temperature by more than 30° C., it is possible to prevent deterioration of the ink components due to the high temperature of the second ink. The second ink can be heated by the inkjet head of the image forming apparatus, an ink channel connected to the inkjet head, an ink tank connected to the ink channel, and the like.

The temperature of the recording medium (or the surface temperature of the white cured film) when the second ink droplets are attached to the recording medium is preferably set to a temperature that is lower than the gelation temperature of the second ink by 10 to 20° C. When the temperature of the recording medium is too low, the second ink droplets become gel too quickly to be pinned. Meanwhile, when the temperature of the recording medium is too high, gelation of the second ink droplets is unlikely to occur, and adjacent droplets may be mixed with each other. By appropriately adjusting the temperature of the recording medium, it is possible to achieve both appropriate leveling and appropriate pinning such that adjacent droplets are not mixed with each other.

The amount of one droplet discharged from each nozzle of the inkjet head depends on the resolution of an image, but is preferably within a range of 0.5 to 10 pL, and more preferably within a range of 0.5 to 2.5 pL in order to form a high-definition image. In order to form a high-definition image with such a droplet amount, it is necessary for the second ink droplets after attachment to the white cured film not to coalesce with each other, that is, it is necessary for the second ink to sufficiently undergo sol-gel phase transition. In the second ink, sol-gel transition is rapidly performed. Therefore, a high-definition image can be stably formed even with such a droplet amount.

The second ink droplets attached onto the white cured film are cooled and rapidly become gel by sol-gel phase transition. As a result, the ink droplets can be pinned without being diffused. In addition, oxygen does not easily enter the second ink droplets, and therefore curing of the actinic ray polymerizable compound is hardly inhibited by oxygen.

The second ink is preferably attached such that the total ink droplet thickness after curing is within a range of 5 to 25 μm. Here, the “total ink droplet thickness” means the maximum thickness of the white cured film formed on the recording medium and the second ink cured film formed on the white cured film.

In a similar manner to the first image forming step, the second image forming step may be performed by either a single pass method or a scan method, but the image forming speed can be increased by adopting the single pass method.

A conveying speed of the recording medium is not particularly limited, but can be set, for example, between 1 and 120 m/s. The higher the conveying speed, the faster the image forming speed.

5. Second Exposure Step

The second exposure step is performed after the second image forming step. In the second exposure step, for example, the unreacted second ink attached onto the white cured film formed on the image forming surface side of the recording medium is irradiated with an actinic ray including light within a wavelength range of 350 to 410 nm to cure the second ink on the white cured film.

As in the first exposure step and the second exposure step, by curing the inks by two-step exposure, exposure can be performed with a light amount suitable for each of the white ink and the second ink unlike a case where an actinic ray curable ink and an actinic ray curable white ink are simultaneously cured by batch exposure to form an image.

For example, it is known that a white ink containing titanium oxide as a pigment is cured with a lower light amount than that of the second ink due to a light scattering effect of titanium oxide. In this way, the appropriate amount of curing light is different between the white ink and the second ink. Therefore, for example, when the white ink and the second ink are continuously printed and are subjected to batch exposure, the white ink is excessively cured and cannot maintain the film strength, and a cured film of the white ink may be deteriorated or peeled, whereas the second ink may be poorly cured due to an insufficient light amount.

6 Image Forming Apparatus

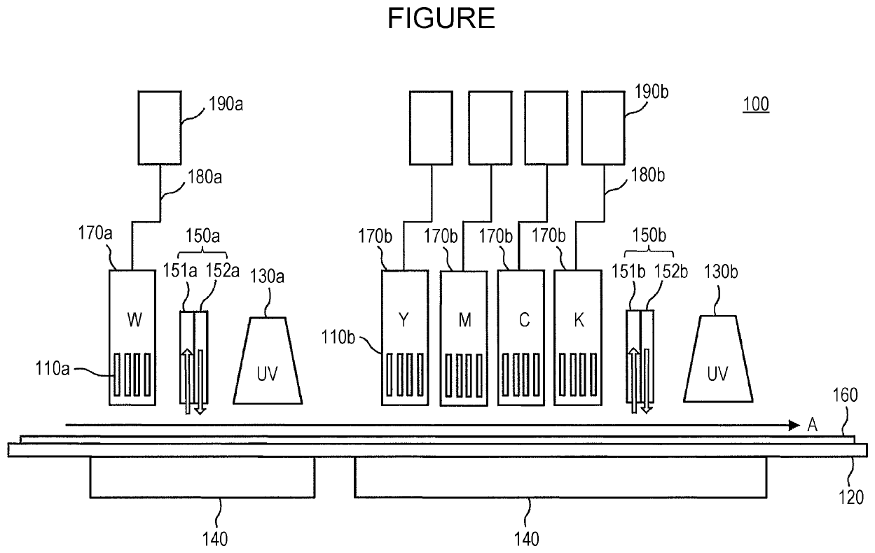

FIG. 1 is a schematic diagram illustrating an exemplary configuration of an inkjet image forming apparatus 100 (hereinafter, also simply referred to as an “image forming apparatus”) according to an embodiment of the present invention. As illustrated in FIG. 1, the image forming apparatus 100 includes a white ink inkjet head 110a, a second ink inkjet head 110b (hereinafter, also simply referred to as “inkjet heads 110a and 110b”), a conveyance path 120, an actinic ray irradiator 130a that irradiates the white ink with an actinic ray, an actinic ray irradiator 130b that irradiates the second ink with an actinic ray (hereinafter, also simply referred to as “actinic ray irradiators 130a and 130b”), a temperature controller 140, an oxygen concentration adjuster 150a that adjusts the oxygen concentration while the white ink is irradiated with an actinic ray, and an oxygen concentration adjuster 150b that adjusts the oxygen concentration while the second ink is irradiated with an actinic ray (hereinafter, also simply referred to as “oxygen concentration adjusters 150a and 150b”). Note that in FIG. 1, an arrow A indicates a conveyance direction of a recording medium 160. The inkjet head 110a, the oxygen concentration adjuster 150a, the actinic ray irradiator 130a, the inkjet head 110b, the oxygen concentration adjuster 150b, and the actinic ray irradiator 130b are disposed in this order in contact with the conveyance path 120 from an upstream side to a downstream side in a conveyance direction of a recording medium.

The image forming apparatus 100 according to an embodiment of the present invention forms an image using the actinic ray curable ink described above.

When the white ink is attached and fixed and the second ink is attached and fixed by a single image forming apparatus, the image forming apparatus 100 having a configuration as illustrated in FIG. 1 can be used. Note that the actinic ray curable inkjet type image forming apparatus includes a line recording type (single pass recording type) apparatus and a serial recording type apparatus. Either type may be selected according to a required resolution of an image and a recording speed, but the line recording type (single pass recording type) apparatus is preferable from a viewpoint of high-speed recording.

Specifically, the image forming apparatus 100 according to an embodiment of the present invention includes an ink discharger that discharges the second ink heated to 40 to 120° C. from the inkjet heads 110a and 110b, the conveyance path 120 that conveys the recording medium 160 to which the discharged actinic ray curable ink is to be attached and attaches the ink to a surface of the recording medium 160 having a surface temperature of 60° C. or lower, the actinic ray irradiators 130a and 130b that irradiate the attached white ink or second ink with an actinic ray, the temperature controller 140 that maintains the recording medium at a predetermined temperature, and the oxygen concentration adjusters 150a and 150b that adjust the oxygen concentration during irradiation with an actinic ray.

As illustrated in FIG. 1, the image forming apparatus 100 further includes a head carriage 170a that houses the inkjet head 110a for an actinic ray curable white ink, a plurality of head carriages 170b that house the inkjet heads 110b for actinic ray curable inks (hereinafter, also simply referred to as “head carriages 170a and 170b”), an ink channel 180a connected to the head carriage 170a, an ink tank 190a that stores a white ink to be supplied through the ink channel 180a, an ink channel 180b connected to the head carriage 170b, and an ink tank 190b that stores an ink to be supplied through the ink channel 180b.

The head carriage 170a houses the inkjet head 110a, and the head carriage 170b houses the inkjet head 110b. The head carriage 170b includes inkjet heads for colors of yellow (Y), magenta (M), cyan (C), and black (K). The head carriages 170a and 170b are fixedly disposed so as to cover the entire width of the recording medium 160, for example.

To the inkjet head 110a, a white ink is supplied from the ink tank 190a. To the inkjet head 110b, the second ink s supplied from the ink tank 190b.

The number of inkjet heads 110a and 110b disposed in a conveyance direction A of the recording medium 160 is set according to the nozzle densities of the inkjet heads 110a and 110b and the resolution of a print image. For example, when an image with a resolution of 1440 dpi is formed using the inkjet heads 110a and 110b with a droplet amount of 2 pl and a nozzle density of 360 dpi, it is only required to dispose the four inkjet heads 110a and the four inkjet heads 110b so as to be shifted from one another with respect to the conveyance direction A of the recording medium 160. When an image with a resolution of 720×720 dpi is formed using the inkjet heads 110a and 110b with a droplet amount of 6 pl and a nozzle density of 360 dpi, it is only required to dispose the two inkjet heads 110a and the two inkjet heads 110b so as to be shifted from each other. The dpi represents the number of ink droplets (dots) per inch (2.54 cm).

The ink tank 190a is connected to the head carriage 170a via the ink channel 180a, and the ink tank 190b is connected to the head carriage 170b via the ink channel 180b. The ink channel 180a is a path that supplies an ink in the ink tank 190a to the head carriage 170a, and the ink channel 180b is a path that supplies an ink in the ink tank 190b to the head carriage 170b. In order to stably discharge ink droplets, the inks in the ink tanks 190a and 190b, the ink channels 180a and 180b, the head carriages 170a and 170b, and the inkjet heads 110a and 110b are preferably heated to a predetermined temperature to maintain a gel state.

The actinic ray irradiators 130a and 130b cover the entire width of the recording medium 160 and are disposed on a downstream side of the head carriages 170a and 170b in the conveyance direction A of the recording medium 160, respectively. The actinic ray irradiators 130a and 130b irradiate ink droplets discharged from the inkjet heads 110a and 110b and attached onto the recording medium 160 with light to cure the droplets, respectively.

The temperature controller 140 is disposed on a lower surface of the recording medium 160 and maintains the recording medium 160 at a predetermined temperature. For example, as illustrated in FIG. 1, the temperature controller 140 may be divided into a part on the head carriage 170a side and a part on the head carriage 170b side. The temperature controller 140 can be, for example, various heaters.

Hereinafter, an image forming method using the image forming apparatus 100 will be described. As illustrated in FIG. 1, in the image forming apparatus 100, the recording medium 160 is conveyed between the head carriage 170a of the image forming apparatus 100 and the temperature controller 140. Meanwhile, the recording medium 160 is adjusted to a predetermined temperature by the temperature controller 140. Subsequently, ink droplets of a high-temperature white ink are discharged onto the recording medium 160 from the inkjet head 110a of the head carriage 170a and attached onto the recording medium 160. Thereafter, the actinic ray irradiator 130a irradiates the ink droplets of the white ink attached onto the recording medium 160 with light to cure the ink droplets.

Furthermore, ink droplets at a high temperature are discharged from the inkjet head 110b of the head carriage 170b for the second ink and attached onto the recording medium 160. Thereafter, the actinic ray irradiator 130b irradiates the ink droplets of the second ink attached onto the recording medium 160 with light to cure the ink droplets.

The image forming apparatus 100 may include the oxygen concentration adjuster 150 that adjusts the oxygen concentration during irradiation with an actinic ray. The oxygen concentration adjusters 150a and 150b adjust the oxygen concentration of an atmosphere surrounding a surface of the recording medium 160 to which the ink is attached when the surface is irradiated with an actinic ray by the actinic ray irradiators 130a and 130b, respectively.

The oxygen concentration adjusters 150a and 150b can include exhaust pipes 151a and 151b connected to an external exhaust apparatus and the like and capable of sucking and exhausting a gas near a surface of the recording medium, and supply pipes 152a and 152b connected to an apparatus that generates a gas having a low oxygen concentration, such as a nitrogen gas generator, capable of supplying a gas having a low oxygen concentration to the vicinity of the surface of the recording medium, and disposed on a downstream side of the exhaust pipe 151, respectively. At this time, by adjusting the exhaust amounts from the exhaust pipes 151a and 151b and the supply amounts of the gas from the supply pipes 152a and 152b, the oxygen concentration in the atmosphere can be adjusted to a desired value of less than 21% by volume. Note that in FIG. 1, the exhaust pipe 151a and the supply pipe 152a are continuous, and the exhaust pipe 151b and the supply pipe 152b are continuous. However, the exhaust pipe and the supply pipe may be separated from each other as long as adjustment to the above oxygen concentration is possible. The supply pipes 152a and 152b are preferably near the actinic ray irradiators 130a and 130b, and may be disposed continuously with the actinic ray irradiators 130a and 130b, for example, respectively.

Note that the oxygen concentration adjusters 150a and 150b may only include the supply pipe 152a and 152b without including the exhaust pipes 151a and 151b, respectively, as long as the oxygen concentration in the atmosphere can be adjusted to a desired value of less than 21% by volume. The oxygen concentration adjuster can preferably adjust the oxygen concentration in the atmosphere to 15% by volume or less, more preferably to 10% by volume or less. A lower limit of the oxygen concentration in the atmosphere that can be adjusted by the oxygen concentration adjuster is not particularly limited, but is preferably 0.01% by volume or more, for example.

Note that the present invention is not limited to the above embodiment. Of course, various changes are permitted within the range of the idea thereof.

For example, in the present invention, the arithmetic average height Sa of the surface of the white cured film to which the second ink is applied only needs to be within the above-described range, and it is not necessary to perform all of the first image forming step, the first exposure step, the second image forming step, and the second exposure step in this order as long as the arithmetic average height Sa of the surface of the white cured film to which the second ink is applied is within the above-described range. Specifically, the second image forming step and the second exposure step described above may be performed on a separately prepared recording medium on which a white cured film having a surface arithmetic average height Sa within the above-described range is formed.

### EXAMPLES

Hereinafter, the present invention will be described in more detail with reference to Examples. The scope of the present invention is not construed as being limited by these Examples.

<Preparation of Pigment Dispersion>

(Preparation of Magenta Pigment Dispersion)

In a stainless steel beaker, 12 parts by mass of EFKA 7701 (pigment dispersant) manufactured by BASF Co., Ltd. and 62 parts by mass of DPGDA (photopolymerizable compound: dipropylene glycol diacrylate) manufactured by Shin Nakamura Chemical Co., Ltd. were put, and were heated and stirred. The obtained solution was cooled. Thereafter, 26 parts by mass of CINQUASIA MAGENTA RT-355D (pigment) manufactured by BASF Co., Ltd. was added thereto, and the resulting mixture was put in a glass bottle together with zirconia beads having a diameter of 0.5 mm. The glass bottle was sealed, and the mixture was dispersed. Thereafter, the zirconia beads were removed to prepare a magenta pigment dispersion M.

(White Pigment Dispersion)

In a stainless steel beaker, 18 parts by mass of EFKA 7701 (pigment dispersant) manufactured by BASF Co., Ltd. and 47 parts by mass of DPGDA (photopolymerizable compound: dipropylene glycol diacrylate) manufactured by Shin Nakamura Chemical Co., Ltd. were put, and were heated and stirred. The obtained solution was cooled. Thereafter, 35 parts by mass of TCR-52 (pigment, titanium oxide) manufactured by Sakai Chemical Industry Co., Ltd. was added thereto, and the resulting mixture was put in a glass bottle together with zirconia beads having a diameter of 0.5 mm. The glass bottle was sealed, and the mixture was dispersed. Thereafter, the zirconia beads were removed to prepare a white pigment dispersion W.

<Preparation of Actinic Ray Curable Inkjet Ink>

(Actinic Ray Curable Inkjet Ink M1)

21.0 parts by mass of the pigment dispersion M prepared above, 25.0 parts by mass of 2PO-NPGDA (PO-modified neopentyl glycol diacrylate), 30.5 parts by mass of DPGDA (dipropylene glycol diacrylate), 13.0 parts by mass of 3EO-TMPTA (3EO-modified trimethylolpropane triacrylate), 7.0 parts by mass of DAROCURE TPO (photopolymerization initiator) manufactured by BASF Co., Ltd., 0.2 parts by mass of Irgastab UV10 (polymerization inhibitor) manufactured by BASF Co., Ltd., 1.5 parts by mass of WE-11 (gelling agent, behenyl stearate) manufactured by NOF Corporation, and 1.7 parts by mass of Unistar M-9796 (gelling agent, stearyl stearate) manufactured by NOF Corporation were mixed and stirred at 80° C. The obtained solution was filtered through a Teflon (registered trademark) 3 μm membrane filter manufactured by ADVATEC Corporation to prepare an ink M1.

(Actinic Ray Curable Inkjet Ink M2)

An actinic ray curable inkjet ink M2 was prepared in a similar manner to the actinic ray curable inkjet ink M1 except that the amount of DPGDA (dipropylene glycol diacrylate) was changed to 33.8 parts by mass, and WE-11 (gelling agent, behenyl stearate) manufactured by NOF Corporation and Unistar M-9796 (gelling agent, stearyl stearate) manufactured by NOF Corporation were not included.

(Actinic Ray Curable Inkjet Ink W1)

28.0 parts by mass of the pigment dispersion W prepared above, 24.0 parts by mass of 2PO-NPGDA (PO-modified neopentyl glycol diacrylate), 23.9 parts by mass of DPGDA (dipropylene glycol diacrylate), 15.0 parts by mass of 3EO-TMPTA (3EO-modified trimethylolpropane triacrylate), 7.0 parts by mass of DAROCURE TPO (photopolymerization initiator) manufactured by BASF Co., Ltd., 0.2 parts by mass of Irgastab UV10 (polymerization inhibitor) manufactured by BASF Co., Ltd., 1.2 parts by mass of WE-11 (gelling agent, behenyl stearate) manufactured by NOF Corporation, and 0.7 parts by mass of Unistar M-9796 (gelling agent, stearyl stearate) manufactured by NOF Corporation were mixed and stirred at 80° C. The obtained solution was filtered through a Teflon (registered trademark) 3 μm membrane filter manufactured by ADVATEC Corporation to prepare an ink W1.

(Actinic Ray Curable Inkjet Inks W2 to W10)

Inks W2 to W10 were prepared in a similar manner to the ink W1 except that the composition of the inkjet ink was changed as illustrated in Tables 2 and 3.

[Image Forming Method]

Each of the inks prepared as described above was put in a line type image forming apparatus (see FIG. 1) including an inkjet head equipped with a piezo type inkjet nozzle (nozzle diameter: 20 μm, number of nozzles: 512 (256 nozzles×2 rows), staggered arrangement, single row nozzle pitch: 360 dpi). The temperature of the inkjet head was set to 80° C. The temperature of a recording medium was adjusted within a range of 30° C. to 55° C. The ink composition was ejected at a droplet speed of about 6 m/s under a discharge condition where the amount of one droplet was 2.5 pl, and recording was performed at a resolution of 1440 dpi×1440 dpi. A recording speed was set to 500 mm/s. An image was formed in an environment of 23° C. and 55% RH.

<Formation of White Image>

A 100% white solid image having a size of 5×5 cm was formed on A4 size aluminum vapor-deposited paper (Hipica #75F manufactured by Tokushu Tokai Paper Co., Ltd.) using one of the white inks W1 to W10. Subsequently, the white image formed was exposed with a light amount of 300 mJ/cm² using an ultraviolet irradiation unit (LED lamp manufactured by Phoseon Technology).

<White Image Formation Under Oxygen Concentration Adjustment>

A 100% white solid image having a size of 5×5 cm was formed on A4 size aluminum vapor-deposited paper (Hipica #75F manufactured by Tokushu Tokai Paper Co., Ltd.) using the white ink W7. Next, a white cured film was formed while the oxygen concentration was adjusted using an image forming apparatus including a gas supply nozzle between an inkjet head and a light source. Specifically, a nitrogen gas generator (N2 IMPACT manufactured by Kofloc Co., Ltd.) was connected to the gas supply nozzle at a pressure of 0.5 MPa·s to cause nitrogen (N₂) gas to flow. By exposure with a light amount of 300 mJ/cm² using an ultraviolet irradiation unit (LED lamp manufactured by Phoseon Technology), a white cured film was formed. Note that at this time, the oxygen concentration near an image was measured and found to be 9% by volume (Example 7).

A white image was formed under oxygen concentration adjustment in a similar manner to the above except that nitrogen gas was supplied at 0.07 MPa. Note that at this time, the oxygen concentration inside a cover was measured and found to be 17% by volume (Comparative Example 5).

<Pressing of White Image>

A 100% white solid image having a size of 5×5 cm was formed on A4 size aluminum vapor-deposited paper (Hipica #75F manufactured by Tokushu Tokai Paper Co., Ltd.) using the white ink W7. Subsequently, the white image formed was exposed with a light amount of 300 mJ/cm² using an ultraviolet irradiation unit (LED lamp manufactured by Phoseon Technology). The cured white image was pressed at 50 kPa using a stainless steel rolling roller (Example 8).

A white image was pressed in a similar manner except that pressing was performed at 5 kPa using the rolling roller (Comparative Example 6).

<Measurement of Arithmetic Average Height Sa>

Here, the arithmetic average height Sa (surface roughness) of a surface of the white cured film was measured by observing the surface with a laser microscope VK-X250 manufactured by KEYENCE CORPORATION with an objective lens magnification of 150 times, and setting an area of a reference length of 20 μm within an area of 20 μm×20 μm at a center of each dot. Note that for the height data, a noise, undulation of a substrate, unevenness caused by the shape of a dot itself, and the like were corrected with a low-pass filter (S-filter) and a high-pass filter (L-filter) before Sa was calculated.

Note that the arithmetic average height Sa was determined by measuring heights in an area of a reference length of 20 μm at ten positions arbitrarily selected on surfaces of 10 dots, and averaging the measured values.

<Color Image Formation>

A 100% magenta solid image having the same size of 5×5 cm was formed on the previously printed white image using the magenta ink M1. Subsequently, the formed magenta image was exposed with a light amount of 500 mJ/cm² using an ultraviolet irradiation unit (LED lamp manufactured by Phoseon Technology).

<Evaluation of Adhesive Force Between Color Ink Coating Film and White Ink Coating Film>

Cello tape (registered trademark) CT-15M manufactured by Nichiban Co., Ltd. was pasted on the formed image, and pressed with a 200 g weight. Thereafter, the tape was peeled off. A density difference (L* value) before and after tape peeling was measured with a densitometer FD-7 manufactured by Konica Minolta Inc.

<Evaluation of Wet Spreading Performance of Color Ink on White Ink (Dot Diameter of Color Ink)>

A single dot of a color ink printed on a cured film of the white ink was observed with a digital laser microscope VK-X250 manufactured by KEYENCE Corporation with an objective lens magnification of 10 times, and the diameters of 20 dots were measured and averaged.

A measurement value in each evaluation was ranked as illustrated in Table 1 below and evaluated. Note that an evaluation rank is better as the number is larger.

TABLE 1

| | | Evaluation rank | | | | |
|---|---|---|---|---|---|---|
| | | 5 | 4 | 3 | 2 | 1 |
| Adhesion | Density difference L* | Less than 5 | 5 to 15 | 15 to 40 | 40 to 70 | More than 70 |
| Wetting | Dot diameter [μm] | More than 40 | 40 to 38 | 38 to 36 | 36 to 34 | Less than 34 |

Tables 2 and 3 below illustrate inks used in Examples 1 to 8 and Comparative Examples 1 to 6, the compositions of white inks, and evaluation results.

TABLE 2

| | | | Example | Example | Example | Example | Example | Example | Example | Example | Example |
|---|---|---|---|---|---|---|---|---|---|---|---|
| | | | 1 | 2 | 3 | 4 | 5 | 6 | 7 | 8 | 9 |
| Magenta ink | Ink No. | | M1 | M1 | M1 | M1 | M1 | M1 | M1 | M1 | M2 |
| White ink | Ink No. | | W1 | W2 | W3 | W4 | W5 | W6 | W7 | W7 | W1 |
| | Pigment | White pigment | 28.0 | 28.0 | 28.0 | 28.0 | 28.0 | 28.0 | 28.0 | 28.0 | 28.0 |
| | dispersion | dispersion | | | | | | | | | |
| | Photopolymerizable | 2PO-NPGDA | 24.0 | 24.0 | 24.0 | 24.0 | 24.0 | 24.0 | 24.0 | 24.0 | 24.0 |
| | compound | DPGDA | 23.9 | 25.1 | 22.6 | 23.0 | 22.4 | 22.6 | 22.9 | 22.9 | 23.9 |
| | | 3EO-TMPTA | 15.0 | 15.0 | 15.0 | 15.0 | 15.0 | 15.0 | 15.0 | 15.0 | 15.0 |
| | Initiator | DUROCURE | 7.0 | 7.0 | 7.0 | 7.0 | 7.0 | 7.0 | 7.0 | 7.0 | 7.0 |
| | | TPO | | | | | | | | | |
| | Polymerization | Irgastab | 0.2 | 0.2 | 0.2 | 0.2 | 0.2 | 0.2 | 0.2 | 0.2 | 0.2 |
| | inhibitor | UV10 | | | | | | | | | |
| | Gelling agent | AMREPS PC | | | | 1.5 | | 1.7 | | | |
| | | WE-11 | 1.2 | 0.4 | 2.0 | | 2.0 | | 1.5 | 1.5 | 1.2 |
| | | UNISTAR | 0.7 | 0.3 | 0.7 | 1.1 | 0.9 | 1.1 | 1.4 | 1.4 | 0.7 |
| | | M-9796 | | | | | | | | | |
| | Crystal nucleating | Poem | | | 0.5 | | | | | | |
| | agent | DS-100A | | | | | | | | | |
| | | PS-5S | | | | 0.2 | | | | | |
| | Crystal growth | Lunac S-90V | | | | | 0.5 | | | | |
| | inhibitor | Hi-Mio-1090 | | | | | | 0.4 | | | |
| | Sum | | 100.0 | 100.0 | 100.0 | 100.0 | 100.0 | 100.0 | 100.0 | 100.0 | 100.0 |
| | Pressing | | | | | | | | | Pressure | |
| | | | | | | | | | | 50 kPa | |
| | Oxygen concentration adjustment | | | | | | | | Oxygen | | |
| | | | | | | | | | concentration | | |
| | | | | | | | | | 9% | | |
| Evaluation | Arithmetic average height Sa | | 0.18 | 0.09 | 0.12 | 0.06 | 0.1 | 0.11 | 0.25 | 0.17 | 0.18 |
| | Adhesion | Density | 3 | 0 | 2 | 0 | 0 | 0 | 10 | 3 | 12 |
| | | difference L* | | | | | | | | | |
| | Wetting | Dot diameter | 39 | 42 | 41 | 42 | 43 | 41 | 39 | 39 | 40 |
| | | [μM] | | | | | | | | | |
| | Adhesion | Density | 5 | 5 | 5 | 5 | 5 | 5 | 4 | 5 | 4 |
| | (Rank evaluation) | difference L* | | | | | | | | | |
| | Wetting | Dot diameter | 4 | 5 | 5 | 5 | 5 | 5 | 4 | 4 | 4 |
| | (Rank evaluation) | [μM] | | | | | | | | | |

TABLE 3

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Magenta ink | Ink No. | | M1 | M1 | M1 | M1 | M1 | M1 |
| White ink | Ink No. | | W8 | W7 | W9 | W10 | W7 | W7 |
| | Pigment dispersion | White pigment | 28.0 | 28.0 | 28.0 | 28.0 | 28.0 | 28.0 |
| | | dispersion | | | | | | |
| | Photopolymerizable | 2PO-NPGDA | 24.0 | 24.0 | 24.0 | 24.0 | 24.0 | 24.0 |
| | compound | DPGDA | 25.8 | 22.9 | 21.7 | 21.5 | 22.9 | 22.9 |
| | | 3EO-TMPTA | 15.0 | 15.0 | 15.0 | 15.0 | 15.0 | 15.0 |
| | Initiator | DUROCURE | 7.0 | 7.0 | 7.0 | 7.0 | 7.0 | 7.0 |
| | | TPO | | | | | | |
| | Polymerization | Irgastab | 0.2 | 0.2 | 0.2 | 0.2 | 0.2 | 0.2 |
| | inhibitor | UV10 | | | | | | |
| | Gelling agent | AMREPS PC | | | | | | |
| | | WE-11 | | 1.5 | 1.4 | 1.4 | 1.5 | 1.5 |
| | | UNISTAR M- | | 1.4 | 0.7 | 0.9 | 1.4 | 1.4 |
| | | 9796 | | | | | | |
| | Crystal nucleating | Poem | | | 2.0 | | | |
| | agent | DS-100A | | | | | | |
| | | PS-5S | | | | | | |
| | Crystal growth | Lunac S-90V | | | | | | |
| | inhibitor | Hi-Mio-1090 | | | | 2.0 | | |
| | Sum | | 100.0 | 100.0 | 100.0 | 100.0 | 100.0 | 100.0 |
| | Pressing | | | | | | | Pressure 5 kPa |
| | Oxygen concentration adjustment | | | | | | Oxygen | |
| | | | | | | | concentration 17% | |
| Evaluation | Arithmetic average height Sa | | 0.02 | 0.48 | 0.03 | 0.03 | 0.39 | 0.34 |
| | Adhesion | Density | 78 | 80 | 65 | 58 | 73 | 56 |
| | | difference L* | | | | | | |
| | Wetting | Dot diameter | 43 | 32 | 41 | 41 | 32 | 37 |
| | | [μm] | | | | | | |
| | Adhesion | Density | 1 | 1 | 2 | 2 | 1 | 2 |
| | (Rank evaluation) | difference L* | | | | | | |
| | Wetting | Dot diameter | 5 | 1 | 5 | 5 | 1 | 3 |
| | (Rank evaluation) | [μm] | | | | | | |

In Examples 1 to 9, the arithmetic average height Sa on a surface of a white cured film was 0.05 μm or more and 0.30 μm or less, and evaluations in both adhesion and wetting were good.

In Comparative Examples 1 to 6, the arithmetic average height Sa of a surface of a white cured film was not within a range of 0.05 μm or more and 0.3 μm or less, and evaluation in either adhesion or wetting was poor, or both evaluations were poor.

Comparing Example 1 with Example 2, it is found that, in Example 2, the amount of the gelling agent is reduced, and therefore the arithmetic average height Sa (surface roughness) of the surface of the white cured film is reduced. This is presumably because the arithmetic average height Sa of the surface of the white cured film was lowered due to reduction of the crystal size of the gel due to reduction of the amount of the gelling agent. In addition, comparing Example 1 with Example 2, in Example 1, Sa is higher and therefore wettability is poorer due to the lotus effect.

In Examples 3 and 4, a crystal nucleating agent was added to the white ink. As a result, the number of crystals was increased, and the size of each crystal was reduced, and therefore it is considered that the arithmetic average height Sa of the surface of the white cured film was low.

In Examples 5 and 6, a crystal growth inhibitor was added to the white ink. As a result, the crystal growth of the gelling agent was inhibited, the growth of each crystal was suppressed, and the crystal size was reduced. Therefore, it is considered that the arithmetic average height Sa of the surface of the white cured film was low.

Comparing Example 7 with Comparative Example 5, Example 7 had a lower arithmetic average height Sa on the surface of the white cured film. This is presumably because, in Example 7, the oxygen concentration was low, the polymerization speed on the coating film surface was faster, the coating film was formed before the crystals were completely deposited on the surface, and therefore the arithmetic average height Sa on the surface of the white cured film was lowered.

Comparing Example 8 with Comparative Example 6, Example 8 had a lower arithmetic average height Sa on the surface of the white cured film. This is presumably because, in Example 8, the white cured film was pressed with a larger force, the unevenness was thereby smoothed, and the arithmetic average height Sa of the surface of the white cured film was lowered.

In addition, in Example 8, Sa was relatively high and therefore wettability was poorer due to the lotus effect.

Comparing Example 9 with Example 1, in Example 9, the magenta ink M2 does not contain a gelling agent, and therefore it is considered that an interaction between the gelling agent in the white cured film and the gelling agent in the magenta ink M2 did not act, and adhesion became lower than that of Example 1.

In Comparative Example 1, the arithmetic average height Sa on the surface of the white cured film was low. This is because, in Comparative Example 1, the uneven shape caused by the crystal of the gelling agent was not formed because of not inclusion of the gelling agent. Although such a white cured film had high wettability, the anchor effect was not obtained, and therefore adhesion was low.

In Comparative Example 2, the arithmetic average height Sa of the surface of the white cured film was high. This is presumably because, in Comparative Example 2, the amount of gelling agent was large, a large amount of crystals were deposited on the surface of the white cured film, and therefore the arithmetic average height Sa of the surface of the white cured film increased. In addition, in Comparative Example 2, adhesion was low. This is presumably because the crystal of the highly hydrophobic gelling agent was deposited on the surface of the white cured film, the Sa was high, and therefore wettability was poor due to the lotus effect.

In Comparative Example 3, the arithmetic average height Sa of the surface of the white cured film was low. This is presumably because, in Comparative Example 3, the amount of the crystal nucleating agent added was too large, and therefore a crystal did not grow on the surface of the white cured film to lower the arithmetic average height Sa. For this reason, in Comparative Example 3, it is considered that wettability was good, but the anchor effect was not obtained, and adhesive force between the cured films was poor.

In Comparative Example 4, the arithmetic average height Sa of the surface of the white cured film was low. This is presumably because, in Comparative Example 4, the amount of the crystal growth inhibitor added was too large, and therefore a crystal did not grow on the surface of the white cured film to lower the arithmetic average height Sa. For this reason, in Comparative Example 4, it is considered that wettability was good, but the anchor effect was not obtained, and adhesive force between the cured films was poor.

In Comparative Example 5, the arithmetic average height Sa of the surface of the white cured film was high. This is because the oxygen concentration in Comparative Example 5 was higher than that in Example 7, the polymerization speed on the surface of the white cured film was therefore insufficient, crystal deposition on the surface was not completely suppressed, and crystals were deposited on the surface of the white cured film to increase the arithmetic average height Sa. In addition, in Comparative Example 5, adhesion was low. This is presumably because the crystal of the highly hydrophobic gelling agent was deposited on the surface of the white cured film, the Sa was high, and therefore wettability was poor due to the lotus effect.

In Comparative Example 6, the arithmetic average height Sa of the surface of the white cured film was high. This is presumably because, in Comparative Example 6, the pressure applied to the white cured film was too weak, and therefore unevenness of the surface of the white cured film was not smoothed to increase the arithmetic average height Sa of the surface. In addition, in Comparative Example 6, adhesion was low. This is presumably because the crystal of the highly hydrophobic gelling agent was deposited on the surface of the white cured film, the Sa was high, and therefore wettability was poor due to the lotus effect.

The image forming method according to an embodiment of the present invention can improve adhesion between the white cured film and the second ink cured film. Therefore, the present invention is expected to expand the range of application of overprinting by an inkjet method, and to contribute to development and spread of the technology in the field.

Although embodiments of the present invention have been described and illustrated in detail, the disclosed embodiments are made for purposes of illustration and example only and not limitation. The scope of the present invention should be interpreted by terms of the appended claims

What is claimed is:

1. An image forming method comprising:
discharging an inkjet actinic ray curable white ink containing an actinic ray polymerizable compound, a gelling agent, and titanium oxide from a nozzle of an inkjet head to attach the inkjet actinic ray curable white ink to a surface of a recording medium;
irradiating the inkjet actinic ray curable white ink attached to the surface of the recording medium with an actinic ray to cure the inkjet actinic ray curable white ink;
discharging an inkjet actinic ray curable ink containing an actinic ray polymerizable compound from a nozzle of an inkjet head to attach the inkjet actinic ray curable ink to a surface of a white cured film obtained by curing the inkjet actinic ray curable white ink; and
irradiating the inkjet actinic ray curable ink attached to the surface of the white cured film with an actinic ray to cure the inkjet actinic ray curable ink, wherein
the surface of the white cured film on which the inkjet actinic ray curable ink lands has an arithmetic average height Sa of 0.05 μm or more and 0.30 μm or less.

2. The image forming method according to claim 1, wherein the arithmetic average height Sa of the surface of the white cured film on which the inkjet actinic ray curable ink lands is 0.05 μm or more and 0.20 μm or less.

3. The image forming method according to claim 1, wherein the gelling agent contains a compound represented by the following general formula (G1) or (G2):
R₁—CO—R₂ (R₁ and R₂ each independently represent a linear or branched hydrocarbon group having 9 to 25 carbon atoms); and General formula (G1)
R₃—COO—R₄ (R₃ and R₄ each independently represent a linear or branched hydrocarbon group having 9 to 25 carbon atoms). General formula (G2)

4. The image forming method according to claim 1, wherein a content of the gelling agent is 0.3% by mass or more and 2.0% by mass or less with respect to a total mass of the inkjet actinic ray curable white ink.

5. The image forming method according to claim 1, wherein the actinic ray curable white ink further contains a crystal nucleating agent.

6. The image forming method according to claim 1, wherein the actinic ray curable white ink further contains a crystal growth inhibitor.

7. The image forming method according to claim 1, wherein the irradiating the inkjet actinic ray curable white ink in which the inkjet actinic ray curable white ink is cured is performed under an oxygen concentration of 15% by volume or less.

8. The image forming method according to claim 1, further comprising smoothing the white cured film between the irradiating the inkjet actinic ray curable white ink and the discharging an inkjet actinic ray curable ink.

9. The image forming method according to claim 1, wherein the inkjet actinic ray curable ink contains a gelling agent.

10. An image forming method comprising:
discharging an inkjet actinic ray curable ink containing an actinic ray polymerizable compound from a nozzle of an inkjet head to attach the inkjet actinic ray curable ink to a surface of a white cured film obtained by curing an actinic ray curable white ink; and
irradiating the inkjet actinic ray curable ink attached to the surface of the white cured film with an actinic ray to cure the inkjet actinic ray curable ink, wherein
the surface of the white cured film on which the inkjet actinic ray curable ink lands has an arithmetic average height Sa of 0.05 μm or more and 0.30 μm or less.
